(19) United States
(12) Patent Application Publication
(10) Pub. No.: US 2007/0263350 A1
(43) Pub. Date: Nov. 15, 2007

(54) PROTECTIVE APPARATUS FOR A PORTABLE DEVICE

(75) Inventors: Tay-Yang Lin, Shenzhen City (CN); Kuan-Hong Hsieh, Shenzhen City (CN)

Correspondence Address: NORTH AMERICA INTELLECTUAL PROPERTY CORPORATION, P.O. BOX 506, MERRIFIELD, VA, 22116, US

(73) Assignee: ENSKY TECHONLOGY (SHENZHEN) CO., LTD., Shenzhen City (CN)

(21) Appl. No.: 11/747,241

(22) Filed: May 11, 2007

(30) Foreign Application Priority Data
May 12, 2006 (CN) 200610060631.8

(51) Int. Cl. G06F 1/16

(52) U.S. Cl. 361/685

(57) ABSTRACT

The invention provides a protective apparatus suit for protecting a portable device and its accessories of the portable device. The protective apparatus includes a holder for holding the portable device; a cover for accommodating at least part of the at least one accessory of the portable device; and a connector for rotatably connecting the holder and the cover. The cover includes a cable retainer for receiving at least part of a cable portion of the at least one accessory, and at least one receptacle for receiving at least part of at least one bulky portion of the at least one accessory. The protective apparatus has a simple design for wrapping the cable onto the protective apparatus and unwrapping the cable from the protective apparatus.

### BACKGROUND

1. Technical Field

The present invention relates to a protective apparatus that is able to not only house a portable device such as a portable electronic device, but also contain an accessory of the portable device.

2. Related Art

Various portable electronic devices are becoming smaller and more sophisticated with each new product release. These portable devices are prone to be damaged accidentally. A typical present-day protective apparatus tends to protect the portable device only, but not the accessories of the portable device. When the portable device is not used, the accessories are put beside the portable device, or separately placed in a bag or a drawer.

The U.S. Patent Application Publication 2005/0255898, entitled “Cell Phone And Holder”, published on Nov. 17, 2005, discloses a cell phone holder. The cell phone holder includes a pocket for holding a cell phone, and a housing on the backing plate of the cell phone holder for accommodating the cable of the cell phone. The housing is a complicated structure with a semi-automatic mechanism for controlling the extension and retraction of an earphone cable therefrom and thereinto.

However the cell phone holder has a disadvantage in that such a semi-automatic mechanism is inconvenient for a user to unwrap the cable from the housing when the cable is not necessary for the cell phone.

Accordingly, it would be advantageous if a protective holder or apparatus had a simple design for easy operation. At the same time, the protective apparatus would also provide protection for the portable device and its accessories.

### SUMMARY

Including in view of the foregoing disadvantages of the conventional art, the present invention provides a new advantageous protective apparatus.

The protective apparatus is suitable for protecting a portable device and accessories of the portable device. The protective apparatus includes a holder for holding the portable device; a cover for accommodating at least part of the at least one accessory of the portable device; and a connector for rotatably connecting the holder and the cover. The cover includes a cable retainer for receiving at least part of a cable portion of the at least one accessory, and at least one receptacle for receiving at least part of at least one bulky portion of the at least one accessory.

A main advantage of the protective apparatus is convenient wrapping of the cable onto the protective apparatus when the portable device is not being used and unwrapping of the cable off from the protective apparatus when the portable device needs to be used. At the same time, the protective apparatus protects the portable device and the accessories held therein.

Other novel features and advantages will become more apparent from the following detailed description when taken in conjunction with the accompanying drawings, in which:

### BRIEF DESCRIPTION OF THE DRAWINGS

FIG. 1 is an isometric view of a protective apparatus in accordance with a first embodiment of the present invention, showing the protective apparatus inverted and in an open state;

FIG. 2 is a front view of the protective apparatus in accordance with the preferred embodiment, showing the protective apparatus in a closed state, and showing parts of a stem, an earphone cable and a plug connector installed with the protective apparatus;

FIG. 3 is a right-side view of the protective apparatus and accessories shown in FIG. 2, partly cut away to show one of two earpieces also installed with the protective apparatus;

FIG. 4 is a back view of the protective apparatus and accessories shown in FIG. 2;

FIG. 5 is a top end plan view of the protective apparatus and accessories shown in FIG. 2;

FIG. 6 is another back view of the protective apparatus and accessories, similar to FIG. 4, but showing the protective apparatus in an open state;

FIG. 7A is a back view of a protective apparatus in accordance with a second embodiment of the present invention, showing the protective apparatus in an open state and parts of a stem and two earpieces installed with the protective apparatus, and showing in phantom an earphone cable also installed with the protective apparatus;

FIG. 7B is an enlarged right-side view of one of the earpieces and part of a cable retainer of the protective apparatus shown in FIG. 7A, the part of the cable retainer being shown in cross-section corresponding to line VII-VII of FIG. 7A; and

FIG. 8 is a back view of a protective apparatus in accordance with a third embodiment of the present invention, showing the protective apparatus in an open state and parts of a stem and two earpieces installed with the protective apparatus, and showing in phantom an earphone cable also installed with the protective apparatus.

### DETAILED DESCRIPTION OF THE EMBODIMENTS

The present invention provides a protective apparatus for protecting a portable device such as a cellular phone, a media player, etc. The protective apparatus is used to hold the portable device and accessories of the portable device. The accessories typically include cable portions and bulkier portions. For example, in the embodiments described herein, an earphone includes an earphone cable 71, a plug connector 72, and a pair of earpieces 8. The earphone cable 71 is a kind of cable portion of the accessories, and the plug connector 72 and the earpieces 8 are bulky portions of the accessories. The cable portion of the accessories also can be a microphone cable or data lines, The bulky portions of the accessories also can be a mouthpiece of a telephone or a Bluetooth transceiver.

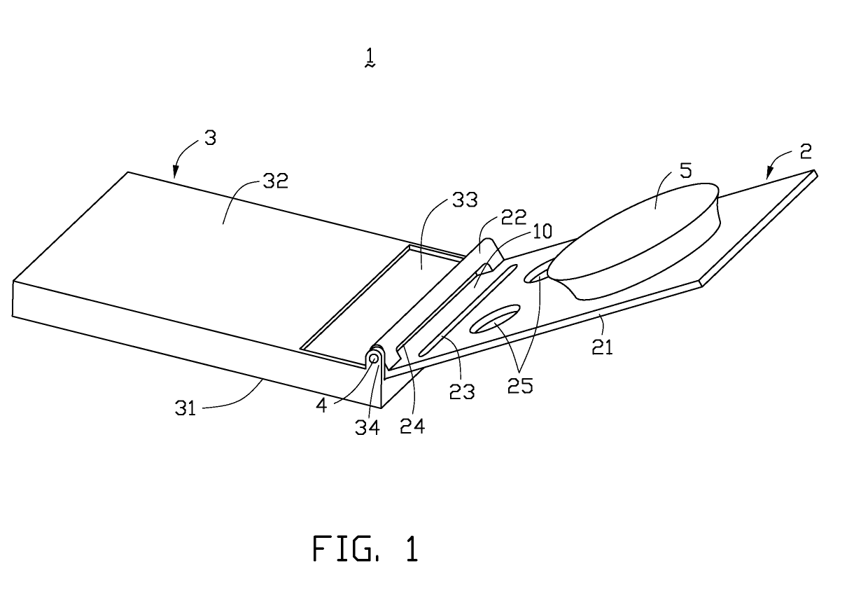

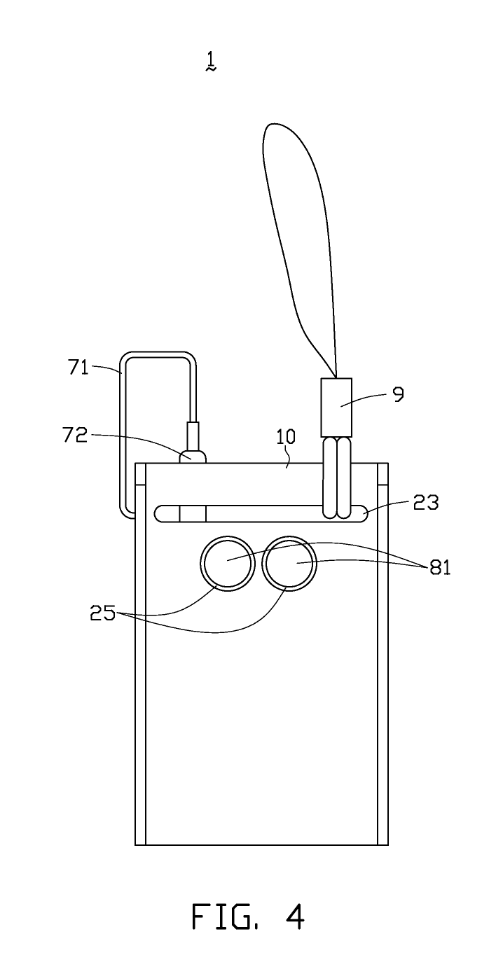

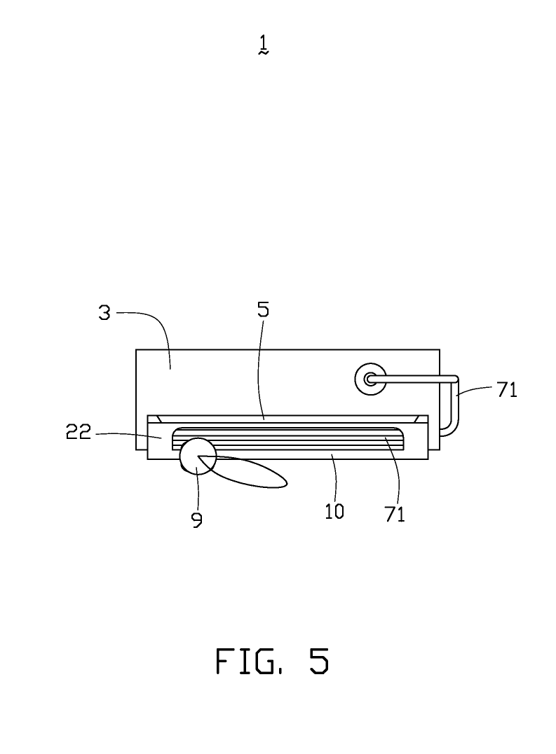

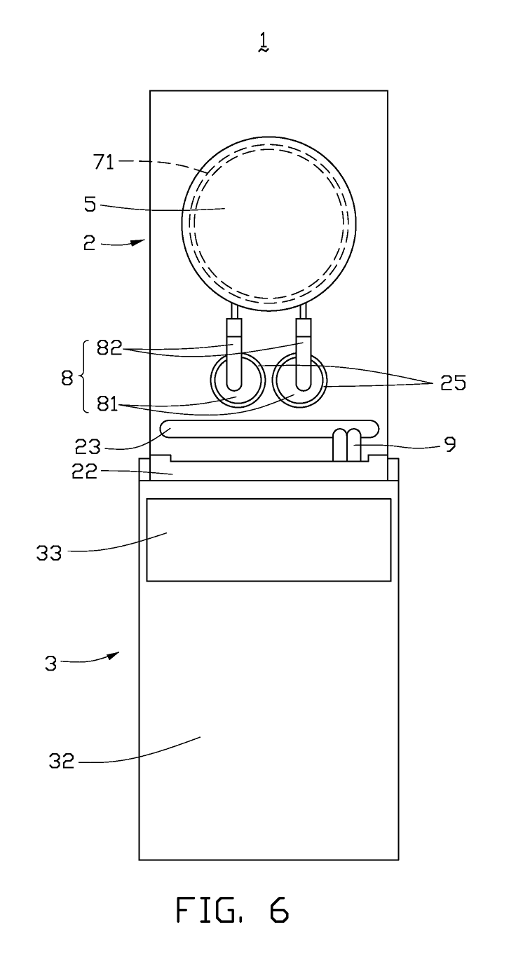

Referring to FIGS. 1 to 6, the exemplary protective apparatus 1 includes a holder 3 for holding the portable device, a cover 2 for placing cable portions and bulky portions of the accessories, and a connector 4 for rotatably connecting the cover 2 and the holder 3.

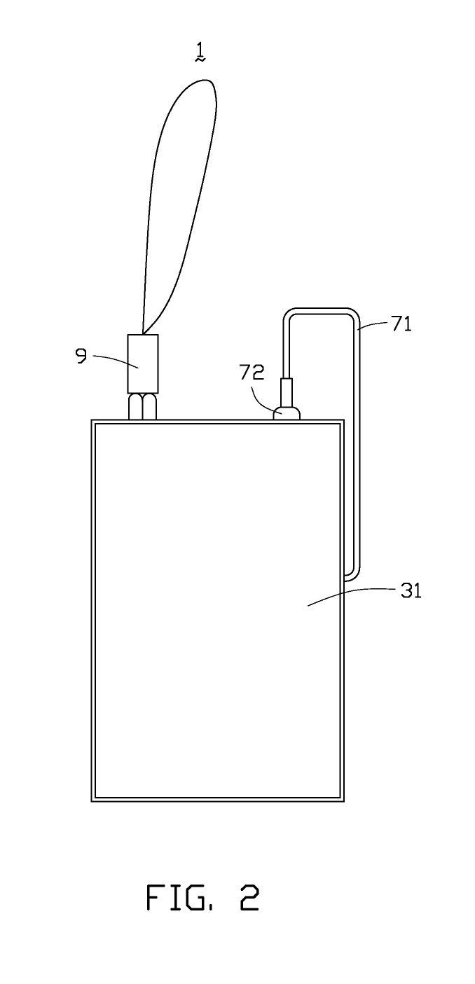

As shown in FIGS. 1 and 2, the holder 3 is made of a sturdy, scratch resistant material so as to limit damage from any collisions the holder 3 sustains. The holder 3 includes a front panel 31 and a back panel 32 cooperatively defining an opening 33. The opening 33 allows the portable device to inserted into the holder 3. Preferably, the whole expanse or a central portion of the front panel 31 is made of transparent material so that information displayed on a screen of the portable device is viewable through the transparent material. The holder 3 further includes a pair of knuckles 34, for connecting the cover 2 to the holder 3.

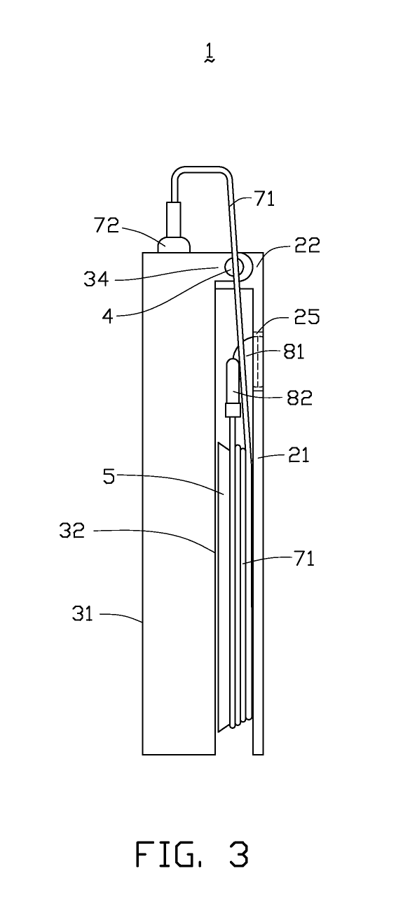

As shown in FIGS. 1 and 3, the cover 2 includes a main panel 21 and a hinge beam 22 perpendicular to the main panel 21. The connecting side of the hinge beam 22 includes an incurved groove. After gluing or sealing the hinge beam 22 onto the main panel 21, the groove configures a gap 24. A hinge pin 4 extends through the hinge beam 22 and the knuckles 34, thereby rotatably hinging the cover 2 to the holder 3. The hinge pin 4, hinge beam 22 and knuckles 34 can instead be other connection means whereby the holder 3 and the cover 2 are rotatably hinged together.

The main panel 21 includes a cable retainer 5 for placing cable portions of the accessories, and a block holder for placing bulky portions of the accessories. From the right-side view shown in the FIG. 3, the cable retainer 5 in the preferred embodiment is a cylinder whose diameter of a free end plane thereof is greater than the diameter of the base plane thereof. Such a structure of the cable retainer 5 prevents the earphone cable 71 from slipping out from the cable retainer 5. In the preferred embodiment shown in FIG. 1, the free end plane of the cable retainer 5 is circular. Alternatively, the free end plane can be oval or rectangular, as long as the free end plane is greater in area than the base plane of the retainer 5.

The block holder may be through holes or concaved shapes for accommodating block portions of the accessories. The block holder may have different shapes and sizes for accommodating different bulky portions of accessories. In the preferred embodiment, a pair of earpiece holes 25 is selected as an example of the block holder for accommodating the earpieces 8. For better and clearer description, the earpieces 8 are divided into a pair of earpiece heads 81 and a pair of stems 82. The earpiece holes 25 are through holes located near the cable retainer 5 in order to fasten the earpiece heads 81.

The protective apparatus further includes a slat member 10 for attaching a detachable handle 9 thereto. The handle 9 enables the portable device to be conveniently carried when it is in the protective apparatus 1. The main panel 21 includes a slot 23 located in the main panel 21, near the gap 24. Therefore, the slot 23 and the gap 24 cooperatively configure the slat member 10.

FIGS. 2 to 5 show the front view, the right-side view, the back view, and the top end plan view of the protective apparatus 1 in the close state. The connector plug 72 is still connected to the portable device (not shown), the earphone cable 71 is wrapped onto the cable retainer 5, and the earpiece heads 81 are inserted into the earpiece holes 25.

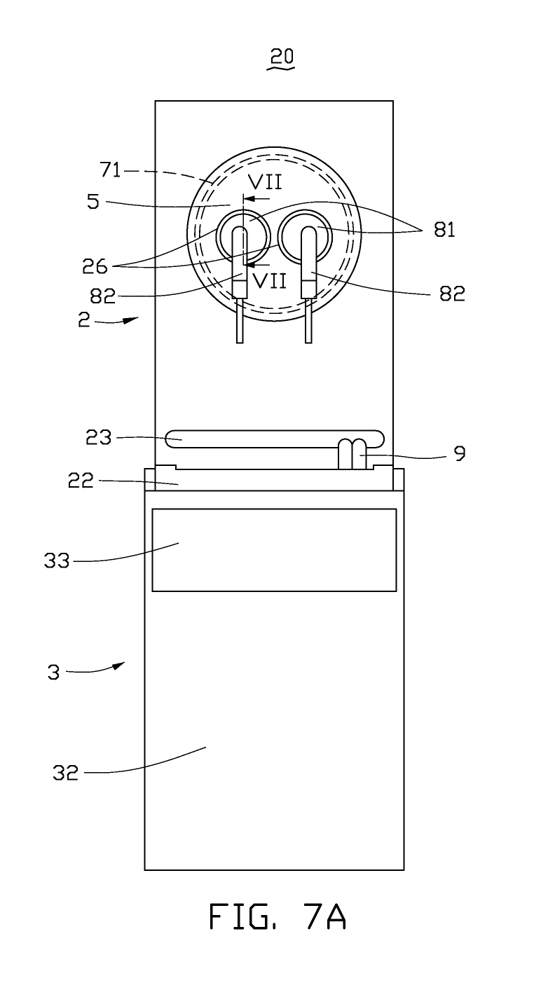

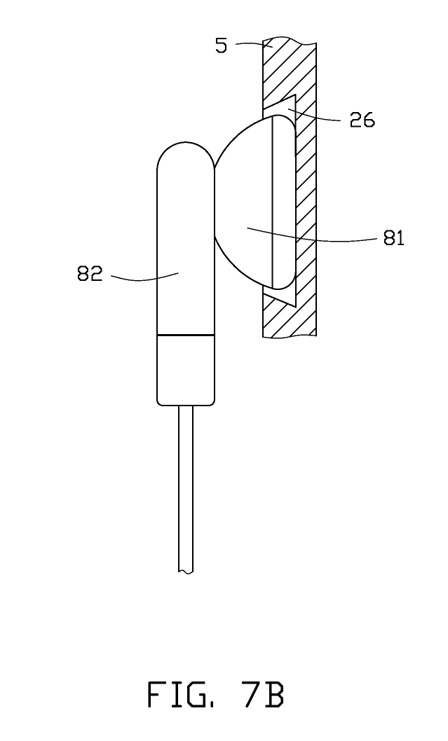

FIG. 7A is a back view of a protective apparatus 20 in accordance with a second embodiment of the present invention, showing the protective apparatus in an open state and parts of a stem and two earpieces installed with the protective apparatus, and showing in phantom an earphone cable also installed with the protective apparatus. In the second embodiment, the earpiece holes 26 are installed in the centre of the cable retainer 5. An inner wall of each of the earpiece holes 26 is made of magnetic materials so as to attract the earpiece heads 81.

FIG. 7B is an enlarged right-side view of one of the earpieces and part of a cable retainer of the protective apparatus shown in FIG. 7A. The part of the cable retainer 5 is shown in cross-section corresponding to line VII-VII of FIG. 7A. It provides another embodiment of the earpiece holes 26. A diameter of an outer side of each earpiece holes 25 is a little less than a diameter of the inner side of each earpiece holes 25. The cable retainer 5 is made of rubber or similar elastic material. When the earpiece heads 81 are inserted into the earpiece holes 26, the narrower outer side plane prevents the earpiece heads 81 from falling out of the earpiece holes 26.

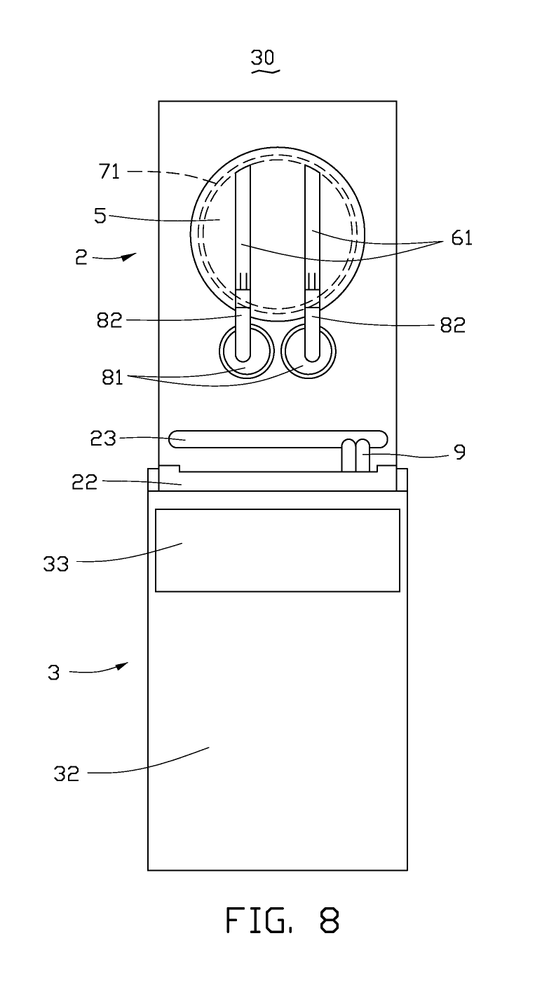

FIG. 8 is a back view of a protective apparatus in accordance with a third embodiment of the present invention, showing the protective apparatus in an open state and parts of a stem and two earpieces installed with the protective apparatus, and showing in phantom an earphone cable also installed with the protective apparatus. The bulky holder in the third embodiment is a pair of grooves 61. As compared to FIG. 7A, the cable retainer 5 is made of rubber or similar elastic material. The cable retainer 5 defines the grooves 61 for fastening the earpieces 8 by inserting the earpiece stems 82 into the grooves 61.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A protective apparatus adapted for a portable device and at least one accessory of the portable device, the protective apparatus comprising:
a holder for holding the portable device;
a cover for accommodating at least part of the at least one accessory of the portable device; and
a connector for rotatably connecting the holder and the cover;
wherein the cover comprises a cable retainer for receiving at least part of a cable portion of the at least one accessory, and at least one receptacle for receiving at least part of at least one bulky portion of the at least one accessory.

2. The protective apparatus according to claim 1, wherein the holder comprises a front panel and a back panel, and the front panel and the back panel cooperatively define an opening configured for allowing the portable device to be inserted into the holder.

3. The protective apparatus according to claim 2, wherein at least a part of the front panel is made of transparent material.

4. The protective apparatus according to claim 3, wherein the holder further comprises a pair of knuckles for rotatably connecting the cover thereto.

5. The protective apparatus according to claim 4, wherein the cover includes a main panel and a hinge beam perpendicular to the main panel.

6. The protective apparatus according to claim 5, wherein the hinge beam is rotatably connected to the knuckle of the holder.

7. The protective apparatus according to claim 6, wherein the cable retainer and the at least one receptacle are fixed on the main panel.

8. The protective apparatus according to claim 7, wherein a diameter of a free end plane of the cable retainer is greater than a diameter of a base plane of the cable retainer.

9. The protective apparatus according to claim 8, wherein the at least one receptacle defines at least one through hole for receiving at least one of the at least one bulky portion of the at least one accessory.

10. The protective apparatus according to claim 9, wherein the earpiece holes are located near the cable retainer.

11. The protective apparatus according to claim 8, wherein the at least one receptacle is concave shape for accommodating at least one bulky portion of the at least one accessory.

12. The protective apparatus according to claim 1, wherein at least one receptacle is two receptacles, and the concave shapes of the receptacles define a pair of earpiece holes for receiving a pair of earpieces.

13. The protective apparatus according to claim 12, wherein an inner wall of each of the earpiece holes comprises magnetic material to attract the earpieces.

14. The protective apparatus according to claim 12, wherein a diameter of an outer side of each of the earpiece holes is less than a diameter of an inner side of each of the earpiece holes.

15. The protective apparatus according to claim 9, wherein the at least one receptacle is two receptacles which define concave holes and a pair of grooves for receiving stem portions of a pair of earpieces.
